(19) United States
(12) Patent Application Publication
(10) Pub. No.: US 2019/0095064 A1
(43) Pub. Date: Mar. 28, 2019

(54) SYSTEMS AND METHODS FOR COLLECTING, MANAGING, PROCESSING AND DISTRIBUTING INFORMATION IN MULTIPLE INDUSTRY SECTORS

(71) Applicant: Robert Alexander, Folsom, CA (US)

(72) Inventor: Robert Alexander, Folsom, CA (US)

(21) Appl. No.: 16/139,049

(22) Filed: Sep. 23, 2018

Related U.S. Application Data
(60) Provisional application No. 62/564,120, filed on Sep. 27, 2017.

(51) Int. Cl. G06F 3/0484; G06F 3/0482; H04L 29/08

(52) U.S. Cl. CPC G06F 3/0484; H04L 67/10; H04L 67/22; G06F 3/0482

(57) ABSTRACT

The embodiments herein provide a system and method for enabling a client to perform activities on a collaborative portal. The system and method include sending, to a client, first display data, which when rendered by the client, depicts the collaborative portal, wherein the collaborative portal supports one or more workspaces, and wherein each workspace, of the one or more workspaces, may be used by a different set of users to perform activities. Further, the system and method include in response to receiving identification data that identifies a user of the client, sending, to the client, second display data, which when rendered by the client, depicts a particular workspace, of the one or more workspaces, for which the user is granted access. The user can access different workspaces with a single sign-in.

### CROSS-REFERENCE TO RELATED APPLICATIONS

This application claims the benefit of U.S. Provisional Application Ser. No. 62/564,120 filed on Sep. 27, 2017, hereby incorporated by reference.

### FIELD OF INVENTION

The present application relates to information collection, management, and distribution, and more particularly, to systems and methods for collecting, managing, processing and distributing information in multiple industry sectors.

### BACKGROUND

Industry professionals constantly face various problems and end up spending enormous amount of energy in locating relevant information for one or more industry sectors. Specifically, in construction industry, various stakeholders need to keep a regular track of information across multiple sources, thereby leading to loss of productivity, time and energy. In use, such multiple sources may include websites, blogs, news portals, brick and mortar stores, local industry events and promotions, technical product literature, and the like.

Subsequently, it is crucial for construction industry professionals to ensure that they are aware about latest developments to learn about new products and methods. At the same time, it is desirable to efficiently obtain such information from relevant sources so that smart business decisions can be taken promptly.

However, presently available solutions to construction industry professionals suffer from multiple disadvantages, which result in inefficiency and delays in business growth. Furthermore, professionals from construction field end up being bombarded with irrelevant information sources, which elevates their existing problems and prevent them from learning about latest developments. Furthermore, due to lack of a collaborative portal to collect and manage the relevant information for one or more industry sectors, the construction industry professionals spend enormous amount of energy in locating relevant information for one or more industry sectors from the multiple sources.

Accordingly, there remains a need in the art to develop new systems and methods for collecting, managing, processing and distributing information in multiple industry sectors, including construction industry and the like.

### SUMMARY

It will be understood that this disclosure is not limited to the particular systems, and methodologies described, as there can be multiple possible embodiments of the present disclosure which are not expressly illustrated in the present disclosure. It is also to be understood that the terminology used in the description is for the purpose of describing the particular versions or embodiments only, and is not intended to limit the scope of the present disclosure.

It is an objective of the present invention to provide a system and method for collecting, managing, processing and distributing information in multiple industry sectors.

It is another objective of the present invention to provide a collaborative portal, wherein the collaborative portal supports one or more workspaces, and wherein each workspace, of the one or more workspaces, may be used by a different set of users to perform activities.

It is still another objective of the present invention to provide a workspace that enables a user to (a) track status of tasks by assigning responsibility of a particular task to a particular user having access to the particular workspace, (b) monitor progress of the particular task, (c) conduct interactive discussions with the particular user, (d) share files with other users having access to the particular workspace, and (e) provide rating to the particular user for the particular task.

It is still another objective of the present invention to provide a mechanism for displaying real-time status of the user on a graphical map.

It is still another objective of the present invention to provide a method for the user to access different workspaces with a single sign-in.

It is still another objective of the present invention to provide a mechanism for bookmarking and storing information related to materials, tools, manufacturers, and suppliers as intended by the user.

Accordingly, the embodiments herein provide a method for enabling a user of a client to perform activities on a collaborative portal. The method includes sending, to a client, first display data, which when rendered by the client, depicts the collaborative portal, wherein the collaborative portal supports one or more workspaces, and wherein each workspace, of the one or more workspaces, may be used by a different set of users to perform activities. Further, the method includes in response to receiving identification data that identifies a user of the client, sending, to the client, second display data, which when rendered by the client, depicts a particular workspace, of the one or more workspaces, for which the user is granted access.

In an embodiment, the particular workspace enables the user to (a) track status of tasks by assigning responsibility of a particular task to a particular user having access to the particular workspace, (b) monitor progress of the particular task, (c) conduct interactive discussions with the particular user, (d) share files with other users having access to the particular workspace, and (e) provide rating to the particular user for the particular task.

In an embodiment, the method further includes displaying real-time status of the user on a graphical map.

In an embodiment, the method further includes managing and distributing information across at least one industry. Further, the method of managing and distributing information across at least one industry includes detecting an input performed by a user, wherein the input is performed to access at least one of an application resource, a processor, a memory unit, and a Graphical User Interface (GUI) available within the central computing device. Further, the method of managing and distributing information across at least one industry includes determining nature of information required by the user in response to detecting the input, wherein the nature of information is dynamically determined by identifying at least one aspect of user access to determine whether the user is searching for a support type of information. Further, the method of managing and distributing information across at least one industry includes extracting the information based on at least one parameter selected by the user in response to determining that the user is searching for the support type of information. Further, the method of managing and distributing information across at least one industry includes distributing the information by rendering the information as a result list to the user.

In an embodiment, the result list includes at least one of product information, service information, query status information, and an electronic link provided to a website of one or more external and internal information sources depending on requirements of the user.

In an embodiment, the method further includes bookmarking and storing all the materials, tools, manufacturers, and suppliers as intended by the user.

In an embodiment, the method further includes receiving a manufacturer-submitted specification for a construction item made up of constituent elements in a two-dimensional image file, receiving a contractor-submitted request for the construction item made up of constituent elements, and generating a three-dimensional illustrative image file based on the two-dimensional image file, and the contractor-submitted request.

Accordingly, the embodiments herein provide a system for enabling a user of a client to perform activities on a collaborative portal. The system includes a memory, and a processor that is coupled to the memory. The processor is configured to send, to a client, first display data, which when rendered by the client, depicts the collaborative portal, wherein the collaborative portal supports one or more workspaces, and wherein each workspace, of the one or more workspaces, may be used by a different set of users to perform activities. In response to receiving identification data that identifies a user of the client, the processor is further configured to send, to the client, second display data, which when rendered by the client, depicts a particular workspace, of the one or more workspaces, for which the user is granted access.

Unlike conventional systems and methods, the proposed system and method is used to collect, manage, process and distribute information in multiple industry sectors. The proposed method and system provide the collaborative portal to collect and manage the relevant information for one or more industry sectors, as a result the construction industry professionals spend less amount of energy in locating relevant information for one or more industry sectors from the multiple sources. Thus, various stakeholders need not to keep a regular track of information across multiple sources, thereby leading to enhancement of productivity, time and energy.

These and other features and advantages of the exemplary embodiments will be apparent from the description provided herein.

### BRIEF DESCRIPTION OF FIGURES

Purposes and advantages of the exemplary embodiments will be apparent to those of ordinary skill in the art from the following detailed description in conjunction with the appended drawings in which like reference characters are used to indicate like elements, and in which:

FIG. 1 illustrates a system for managing information in multiple industry sectors, according to an embodiment disclosed herein;

FIG. 2 is an illustration of a user interface displayed by the client, according to an embodiment of the invention;

FIG. 3 is an illustration of an exemplary user interface of a user profile displayed by the client, according to an embodiment of the invention;

FIG. 4 is an illustration of an exemplary user interface for managing one or more representatives, according to an embodiment of the invention;

FIG. 5 is an illustration of an exemplary user interface of a dashboard that is accessed by a supplier administrator for managing activities related to one or more suppliers, according to an embodiment of the invention;

FIG. 6 is an illustration of an exemplary user interface for checking and managing the events, according to an embodiment of the invention;

FIG. 7 is an illustration of an exemplary user interface that facilitate the user to manage one or more tools purchases, according to an embodiment of the invention;

FIG. 8 is an illustration of an exemplary user interface that facilitates the user to manage information related to one or more manufacturers, according to an embodiment of the invention;

FIG. 9 is an illustration of an exemplary user interface that facilitates the user to manage information related to one or more suppliers, according to an embodiment of the invention;

FIG. 10 is an illustration of an exemplary user interface of a dashboard that is accessed by a store administrator for managing activities related to one or more stores, according to an embodiment of the invention;

FIG. 11 is an illustration of an exemplary user interface that facilitate the user to manage one or more materials purchases, according to an embodiment of the invention;

FIG. 12 is an illustration of an exemplary user interface that facilitate the user to search, and select three-dimensional illustrative image files related to installation methods from a variety of manufactures, according to an embodiment of the invention;

FIG. 13 is an illustration of an exemplary user interface that displays one or more graphical indicator on a graphical map in response to a user query for at least one of materials, tools, and suppliers, according to an embodiment of the invention;

FIG. 14 is an illustration of an exemplary user interface that displays one or more group of images captured by one of the industry stakeholders, according to an embodiment of the invention;

FIG. 15 is an illustration of an exemplary user interface that facilitate the user to manage information related to an association, according to an embodiment of the invention;

FIG. 16 is an illustration of an exemplary user interface that facilitate the user to browse, search, purchase and download one or more digital material, according to an embodiment of the invention;

FIG. 17 is an illustration of an exemplary user interface that facilitates the user to bookmark and store information related to materials, tools, manufacturers, and suppliers as intended by the user, according to an embodiment of the invention;

FIG. 18 is a flow chart illustrating a method for enabling a user of a client to perform activities on a collaborative portal, according to an embodiment as disclosed herein; and

FIG. 19 illustrates a computing environment implementing the method for enabling a user of a client to perform activities on a collaborative portal, according to embodiments disclosed herein.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes, which may be substantially represented in computer readable medium and executed by a computer or processor, whether such computer or processor is explicitly shown.

### DETAILED DESCRIPTION OF INVENTION

Various embodiments of the present disclosure will now be described in detail with reference to the accompanying drawings. In the following description, specific details such as detailed configuration and components are merely provided to assist the overall understanding of embodiments of the present disclosure. Therefore, it should be apparent to those skilled in the art that various changes and modifications of the embodiments described herein can be made without departing from the scope and spirit of the present disclosure. In addition, descriptions of well-known functions and constructions are omitted for clarity and conciseness.

Some embodiments, illustrating its features, will now be discussed in detail below in conjunction with the accompanying figures. The words “comprising,” “having,” “containing,” and “including,” and other forms thereof, are intended to be equivalent in meaning and be open ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise. Herein, the term “or” as used herein, refers to a nonexclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

Also, the various embodiments described herein are not necessarily mutually exclusive, as some embodiments can be combined with one or more other embodiments to form new embodiments.

As is traditional in the field, embodiments may be described and illustrated in terms of blocks, which carry out a described function or functions. These blocks, which may be referred to herein as units or modules or the like, may be implemented by analog and/or digital circuits such as logic gates, integrated circuits, microprocessors, microcontrollers, memory circuits, passive electronic components, active electronic components, optical components, hardwired circuits and the like, and may optionally be driven by firmware and/or software.

In use, embodiments of the present invention are aimed at providing users an opportunity to efficiently locate and contact one or more industry stakeholders, such as, for example, but not limited to tile suppliers, manufacturers, associations, and the like. In addition to efficiently locating and contacting such stakeholders, the present invention further provides additional features to users, such as, for example, but not limited to, creating awareness about latest developments, informing and educating about latest products and methods, exploring local industry events and promotions, and the like. Subsequently, embodiments of the present invention allow the users to connect more exclusively with industry representatives for products specifications to focus on the location problems.

Furthermore, various embodiments of the present invention are aimed at providing all-inclusive industry product learning to construction industry professionals. In use, the present invention includes a communication platform that is capable of providing significant advantages to the users, such as, for example, but not limited to, providing users with a single point access platform to solve various different needs, instead of presently available inefficient and non-productive options, which require the users to download multiple apps, browse multiple online website sources, or visit brick and mortar stores to learn about industry products from manufacturers.

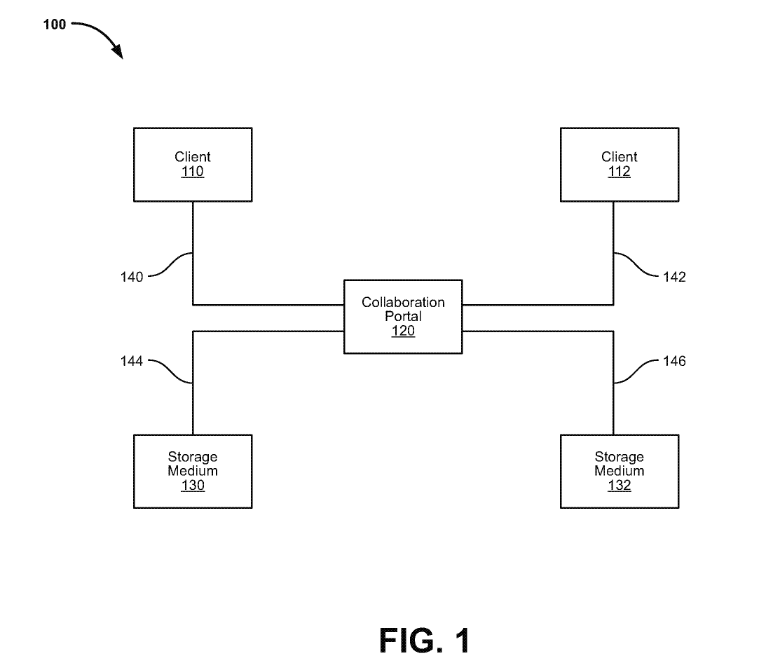

Referring to FIG. 1, illustrates a system 100 for managing information in multiple industry sectors, including construction industry and the like, in accordance with an embodiment of the present invention. The system 100, or a portion thereof, may be referred to as a collaborative portal 120. The system 100 may be used by a plurality of users to collaboratively perform different activities, according to embodiments of the invention. In an embodiment, the system 100 comprises a client 110, a client 112, a collaboration portal 120, a storage medium 130, a storage medium 132, and one or more communication links 140, 142, 144, and 146.

The clients 110 and 112 each represent any mechanism capable of (a) displaying digital data to a user and (b) communicating with the collaboration portal 120. In an embodiment, the portal 120 supports one or more workspaces. A user uses a client to interact with the collaboration portal or server 120 to perform activities on one or more workspaces. Non-limiting, illustrative examples of the clients 110 and 112 include a web browser, a software application, a cell phone, a personal digital assistance (PDA), a wireless device, and a personal computer.

The clients 110 and 112 may display a user interface to the user to facilitate the user's interaction with the clients. For example, if the client 110 is implemented using a web browser, then client 110 may depict digital data on a web page (in other words, the user interface) through which a user may interact with the client 110. As another example, if the client 110 is implemented using the cell phone, then the client 110 may depict digital data on a physical display of the cell phone through which the user may interact with the client 110. Note that while only two clients are depicted in FIG. 1 for ease of explanation, embodiments of the invention may include any number of clients. Indeed, in some embodiments, the user of system 100 may, but need not, employ more than one client, e.g., a user may use a personal computer, a cell phone, and a personal digital assistant (PDA) to communicate with the collaboration portal 120.

In an embodiment, collaboration portal 120 represents any computerized entity, such as one or more software components, capable of interacting with a client (such as the client 110 and 112) and with a storage medium (such as the storage mediums 130 and 132). In an embodiment, collaboration portal 120 is responsible for servicing requests from clients and storing data to and retrieving data from the storage medium. The functions performed by the collaboration portal 120 enables the user of the client 110 to perform different activities. While the collaboration portal 120 is depicted in FIG. 1 as a single entity, in some embodiments, the collaboration portal 120 may be implemented as two or more entities. For example, in an embodiment, the collaboration portal 120 may be implemented using a web server and an application server. As another example, the collaboration server 120 may be implemented as a server cluster. In certain embodiments of the invention, the collaboration server 120 may be implemented using the Enterprise Collaboration Workspace product.

Each of the storage mediums 130 and 132 represent any medium for persistently storing digital data. Non-limiting, illustrative examples of storage medium 130 include a file server and a database management system (DBMS). In the embodiment, the storage mediums 130 or 132 may be implemented using a DBMS that comprises a database server and a database. In an embodiment, the data stored in storage medium 130 may represent any number of physical and tangible objects, e.g., data stored in storage medium 130 may represent financial data about an organization, a business, or data about any real-world activity. While the storage mediums 130 and 132 are depicted as single entities, each may be implemented as one or more separate entities to promote scalability and ensure operability, e.g., storage medium 130 may be implemented using a parallel server, server cluster, or data stored therein may periodically backed up to a separate storage device.

The communication link 140 may be implemented by any medium or mechanism that provides for the exchange of data between the client 110 and the collaboration portal 120. The communication link 142 may be implemented by any medium or mechanism that provides for the exchange of data between the client 112 and the collaboration portal 120. The communication link 144 may be implemented by any medium or mechanism that provides for the exchange of data between the collaboration portal 120 and the storage medium 130. The communication link 146 may be implemented by any medium or mechanism that provides for the exchange of data between the collaboration portal 120 and the storage medium 132. Non-limiting, illustrative examples of the communication links 140, 142, 144, and 146 include, without limitation, a network such as a local area network, a wide area network, a radio network, a virtual private network, an internet area network, a metropolitan area network, a satellite network, Wi-Fi, Bluetooth Low energy, a wireless network, and a telecommunication network. Examples of the telecommunication network include, but are not be limited to a global system for mobile communication (GSM) network, a general packet radio service (GPRS) network, third Generation Partnership Project (3GPP), an enhanced data GSM environment (EDGE) and a Universal Mobile Telecommunications System (UMTS). The present invention should not be limited in its communication nomenclature.

In accordance with an embodiment of the present invention, the collaboration portal 120 includes a notification module for providing one or more industry notifications to the users. In use, by way of such notifications, users always stay connected with various developments in the construction industry. Additionally, this allows the users to collect additional information to improve business efficiency and productivity by being better informed about industry related developments as compared to traditional sources. Those of ordinary skills in the art will appreciate that the notification module may be combined with other modules of the collaboration portal 120 to provide users with multiple kinds of contents, such as, for example, but not limited to, methods, specifications, installation pdfs, videos, suppliers, manufacturers and associations notifications on classes, events and promotions, and the like. Operationally, such notifications are provided to users in an easily accessible manner, and multiple modules of the collaboration portal 120 may be configured to provide such notifications and related information readily to the users at their fingertips.

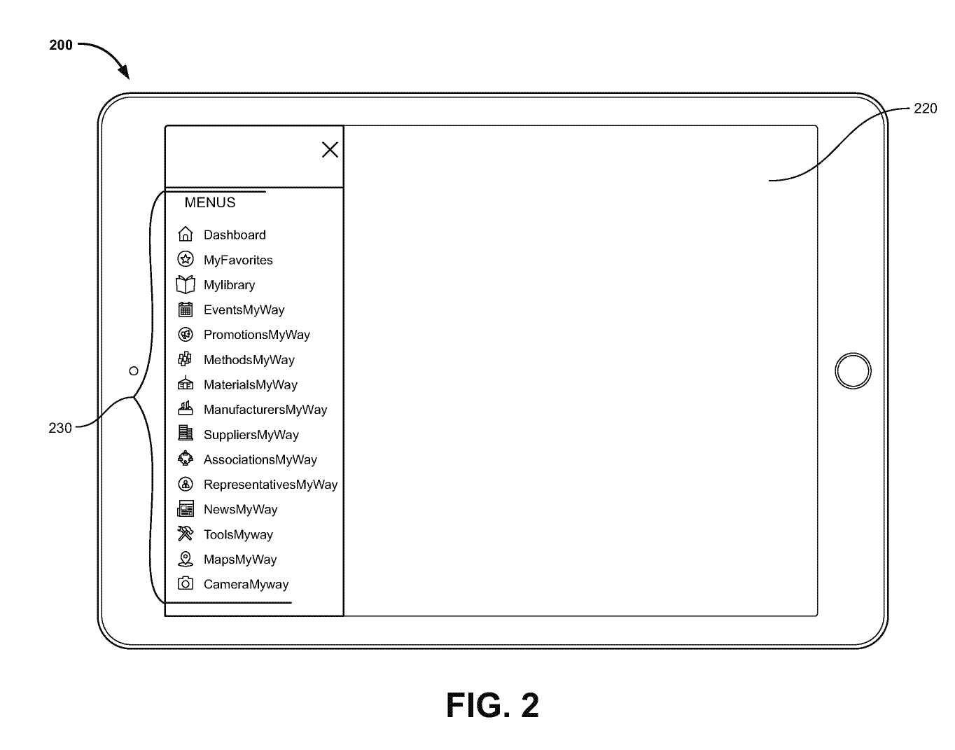

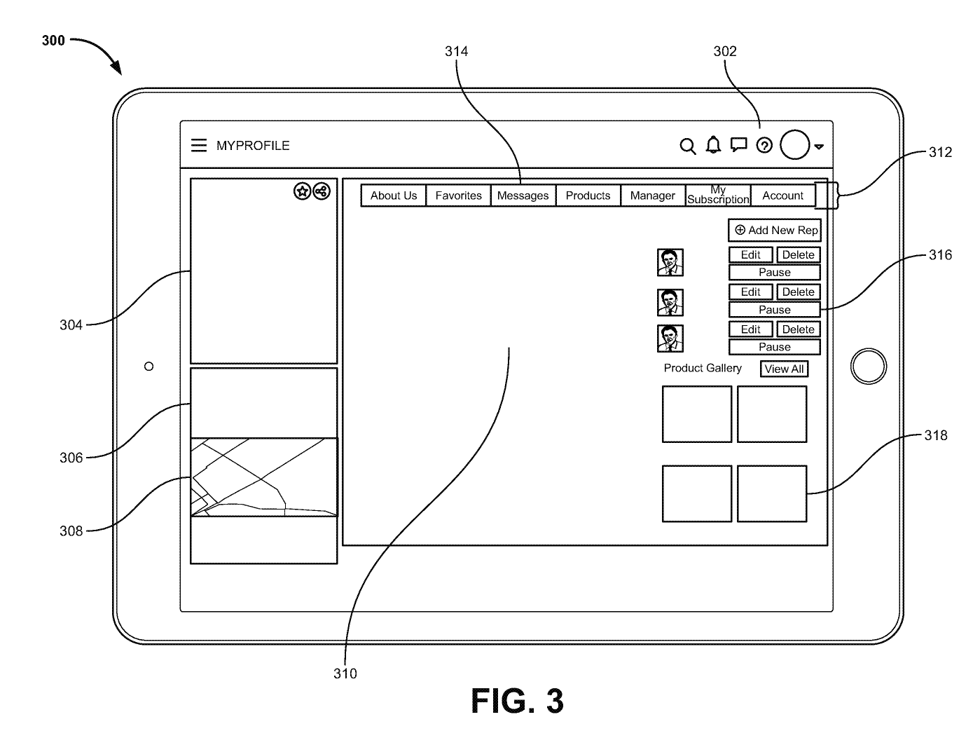

In an embodiment, the user of the client 110 provides valid credentials to access the collaboration portal 120. In an embodiment, the valid credential includes a registered user name or email address, and password. The collaboration portal 120 enables the user to choose an option for storing the username and password for auto login to the collaboration portal 120. The user can reset the password when required. In an embodiment, the collaboration portal 120 is configured to send an email to the registered email of the user in order to authenticate a valid email. With the registered user name or email address, and password, the user can login to the collaboration portal 120 and access one or more workspaces. A list of workspaces is shown in FIG. 2. After login to the collaboration portal 120, the user can create his/her display profile. An exemplary user interface of a user profile is illustrated in FIG. 3.

FIG. 2 is an illustration 200 of a user interface displayed by the client 110 or 112, according to an embodiment of the invention. The Illustration 200 depicts the client 110 or 112 that is implemented using a web browser. The client 110 displays a user interface 220 that is implemented as a web page. The user interface 220 displays, to the user of the client 110, data pertaining to one or more workspaces, Dashboard menu, and the like. A workspace is a shared content area that is associated with a particular industry or the user. For example, a workspace may be associated with a particular industry's material management process. For example, a workspace may be associated with data related to one or more events of the user. A workspace may be used by a set of users having access to the workspace to perform activities related to supplying material that can be used in building construction. A user that has access to a particular workspace may tailor his or her view of the workspace. Thus, as shall be explained in more detail below, while users who have been granted access to a particular workspace may have access to the same data, each user may tailor or configure how he or she views or interacts with the data. The user interface 220 also depicts a list of workspaces. The workspaces may be used to access user interfaces that enable or provide the various functions depicted in the list of workspaces. For example, a user interface element or a pagelet 230 may be depicted by selecting the “MethodsMyWay” option from the list of workspaces. The user can select the desired user interface element or the pagelet 230 by clicking or tapping the option.

A workspace is intended to collect, manage process and distribute all data associated with a particular industry or a user. In an embodiment, the system 100 may employ a plurality of workspaces that are arranged in a hierarchy, such as a tree. In such an embodiment, the hierarchy of workspaces may correspond to a hierarchy of business units or organizational levels of the industry. Status information about activities pertaining to particular workspace may be made available to one or more workspaces. In another embodiment, the system 100 may employ a plurality of workspaces that are displayed as individual user interface element of the user interface 220. In some embodiments of the invention, the clients 110 or 112 are capable of clearly and efficiently presenting one or more workspaces using a split screen or by using tabs to enable the user to quickly tab back and forth between workspaces. In some embodiments, clients are capable of display data from multiples workspaces simultaneously, as long as the user interface of the client clearly identifies, to the user, which workspace is associated with the displayed data.

In an embodiment, the user may create and define a particular workspace by supplying information about the characteristics of the workspace to the collaboration portal 120. For example, the user may configure which users should be invited to join the workspace. In an embodiment, the user may create a workspace by using a template that identifies a set of default configuration information for the workspace. In this way, the process of creating a workspace may be simplified and streamlined, since many of the characteristics of a workspace may not change from one financial close process to another.

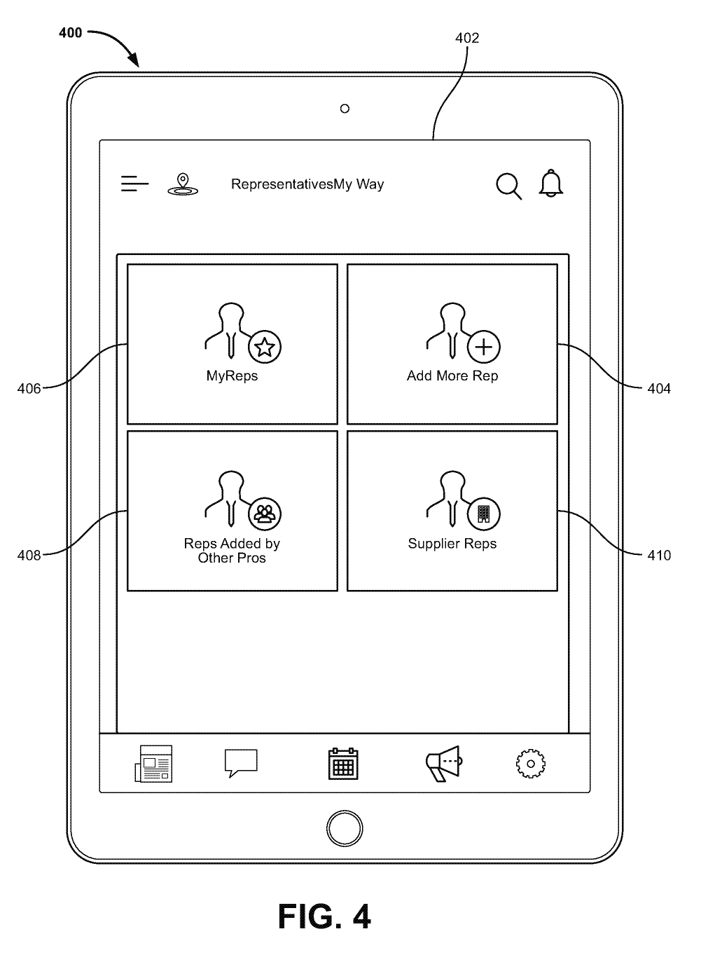

FIG. 3 is an illustration 300 of an exemplary user interface 302 of a user profile displayed by the client 110, according to an embodiment of the invention. The user interface includes multiple sections to display different types of information. In an example, a user's profile name and a profile image are displayed on section 304. The user's contact information is displayed on the section 306. The location of the user is displayed on section 308 though a graphical map. A color changing icon displayed on the graphical map indicates whether the user is online or offline. For example, if the color changing icon is green, it is interpreted as the user is online on the collaboration portal 120. Similarly, if the color changing icon is red, it is interpreted as the user is offline on the collaboration portal 120. Further, a brief write-up about the user is displayed on the section 310. A multiple tab option is displayed on the section 312. The user can tap or select different tabs by clicking the individual icon of the corresponding tab. For example, the user can select the messages tab 314 to check the messages intended for the user. In an exemplary embodiment, a floating graphical indicator that displays a number is provided on the messages tab 314 to indicate number of new messages that has been received. Further, an individual message of the messages tab 314, upon selected, display a concatenated message format including all the messages that are exchanged between a sender and a receiver in the past. The user can seamlessly access the tabs displayed on the section 312. Further, a part of a workspace is displayed on the section 316. For example, a list of representatives that are selected by the user is displayed on the section 316. The selected representatives are also included in the workspace denoted by “RepresentativesMyWay”, as shown in FIG. 4. Further, one or more products for which the user has shown interest or that the user has selected are displayed on the section 318.

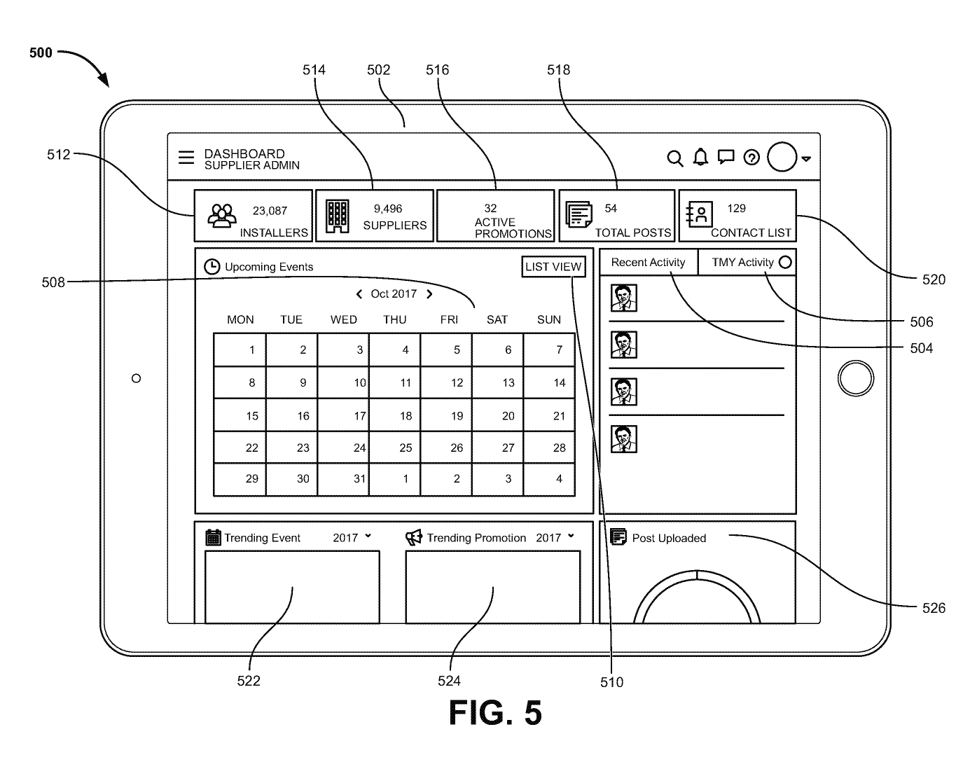

FIG. 4 is an illustration 400 of an exemplary user interface 402 for managing one or more representatives, according to an embodiment of the invention. The exemplary user interface 402 allows the users to connect to more exclusively with industry representatives for products specifications to focus on location problems. For example, if the user purchases a machine or material from a supplier and the location of the supplier is distant form the location of the user. The user can contact the concerned person from the supplier to get the machine repaired in case any defect. The user can experience delay in the service as the person from the supplier has to travel to user's location for service. Thus, to avoid such scenarios, suppliers recommend one or more representatives for the location of the user, and the user can have better user experience with the representatives. Hence, solving the location problems. The user can add one or more representatives by selecting an icon 404. Further, the user can check the representative selected by him/her by selecting the icon 406. Furthermore, the user can check the representative added by other users by selecting the icon 408. Additionally, the user can check the representative added by one or more supplier by selecting the icon 410. An exemplary user interface of a dashboard that is accessed by a supplier administrator for managing activities related to one or more suppliers is illustrated in FIG. 5.

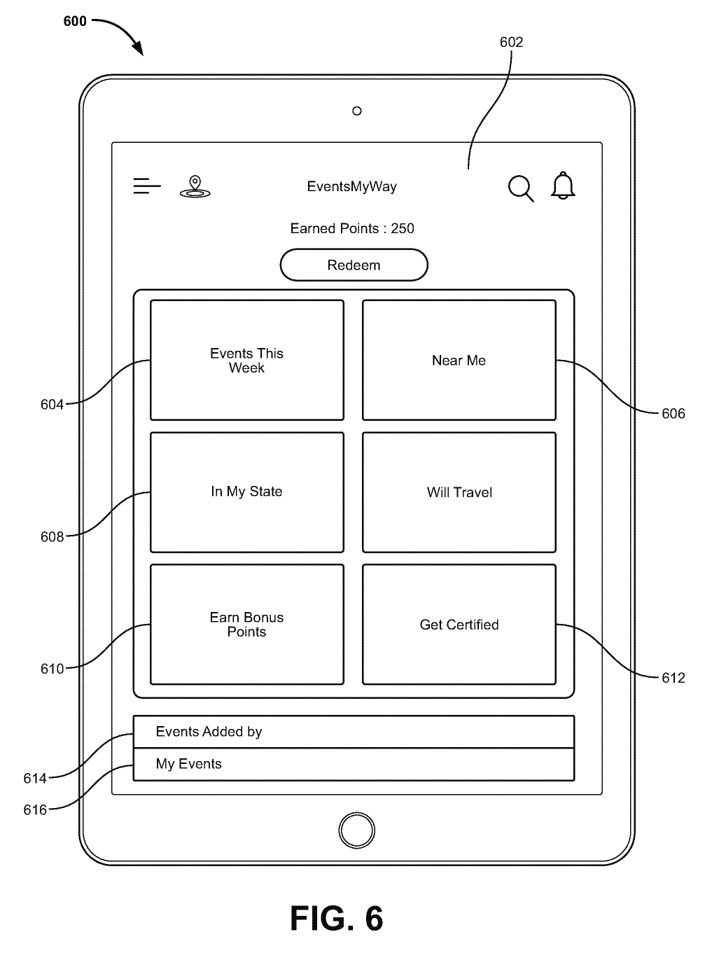

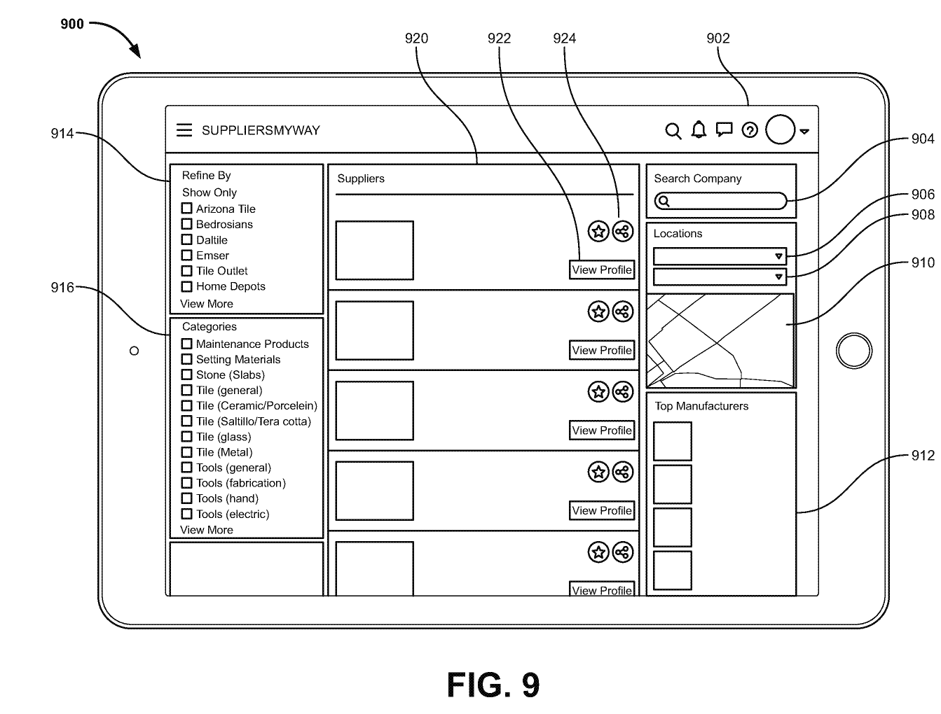

FIG. 5 is an illustration 500 of an exemplary user interface 502 of a dashboard that is accessed by a supplier administrator for managing activities related to one or more suppliers, according to an embodiment of the invention. In an embodiment, the dashboard is accessed by one of an installer administrator, a supplier administrator, a manufacturer administrator, and an association administrator. One or more recent activities of the supplier is displayed on section 504. The activities can be sorted with most recent activity on the top and the historical activities at the bottom. Similarly, one or more past activities can be accesses by selecting the tab 506. Further, the user can check upcoming events of the supplier on the section 508. In an embodiment, the events are related to one of the manufacturers and an association. In an embodiment, the user can change a layout of the section 508 to view the upcoming events, for example, to a list view by clicking a button 510. In an embodiment, the event section is integrated with a calendar application. The event section may also be integrated with a third-party calendar application too. Further, the user can check the number of installers interacted with the supplier by selecting the tab 512. The user can check the number of suppliers interacted with the supplier by selecting the tab 514. The user can check the amount of materials that is supplied to the supplier by selecting the tab 516. The user can check the number of manufacturers interacted with the supplier by selecting the tab 518. The user can check amount of points earned by an installer by selecting the tab 520. The user can check a trending event on the section 522. The user can check a trending promotion on the section 524. The user can check the number of posts, for example, news, promotions, and events, upload to the collaborative portal 120 on the section 526. An exemplary user interface for checking and managing the events is illustrated in FIG. 6. Further, an exemplary user interface that facilitate the user to search, and verify information related to one or more suppliers is illustrated in FIG. 9.

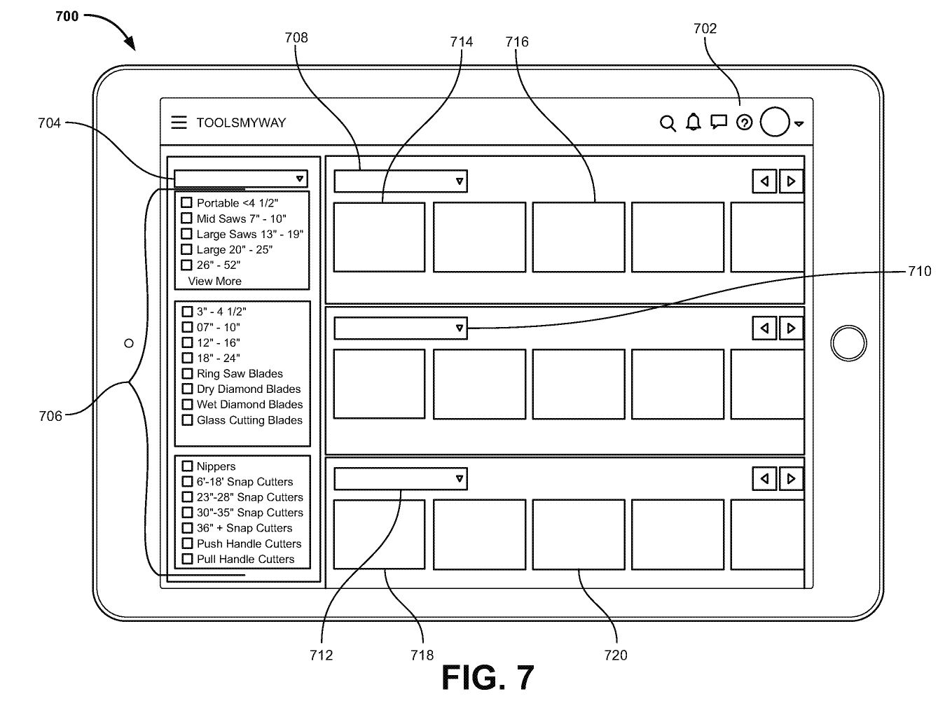

FIG. 6 is an illustration 600 of an exemplary user interface 602 for checking and managing the events, according to an embodiment of the invention. The user can track from the exemplary user interface 602 all about the events of one or more vendors and can easily connect to their industry of interest from their local city or in a nation to understand where, how and when their industry is holding their Events and Promotion and what they're innovating or informing users about. The user can check the events for a particular week by selecting a tab 604. The user can check the events near to the location of the user by selecting a tab 606. The user can check the events for a particular geography, for example, a particular state, by selecting a tab 608. The user can check the events where the user can earn bonus points by selecting a tab 610. The user can check the events where the user can get a certificate by selecting a tab 612. The user can check the events added by him/her by selecting a tab 614. The user can check the past, present, and upcoming events of the user's interest by selecting a tab 616. The user can redeem the earned bonus points against one or more materials or tools, wherein one or more material description is available in one of the workspaces of the collaborative portal 120, and one or more tool description is available in one of the workspaces of the collaborative portal 120. An exemplary user interface that facilitates the user to search, select and purchase one or more tools is illustrated in FIG. 7.

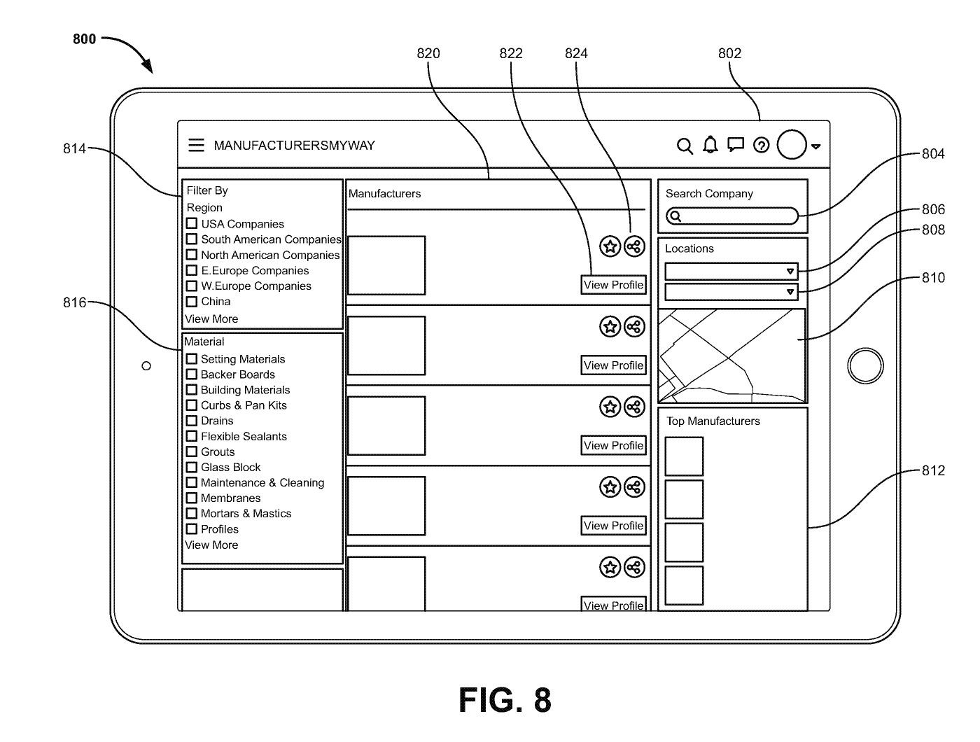

FIG. 7 is an illustration 700 of an exemplary user interface 702 that facilitate the user to manage one or more tools purchases, according to an embodiment of the invention. The exemplary user interface 702 that facilitate the user to search, select and purchase one or more tools. The user selects a drop-down menu 704 for choosing a menu item, for example, tools. If the user selects the menu option as “tools”, one or more list of tools is displayed as shown in the exemplary user interface 702. The user can select one or more options on the section 706 by selecting the checkboxes. Further, the user can select one or more types of tools from a drop-down menu 708, 710, and 712. For example, the user chooses a tool such as mid saws having size between 7 inches to 10 inches by selecting the checkboxes on the section 706. Further, the user selects the types of the tool as “tile wet saws” from the drop-down menu 708. In response to the user selection, name of the tile wet saws manufacture is displayed on the section 714 and a list of tile wet saws are displayed in the section 716. In another example, the user chooses nippers having size between 6 inches to 18 inches by selecting the checkboxes on the section 706. Further, the user selects the type of tool as “snap cutter” from the drop-down menu 712. In response to the user selection, name of the tile snap cutter manufacture is displayed on the section 718 and a list of snap cutters is displayed in the section 720. An exemplary user interface that facilitates the user to search, and select one or more manufacturer is illustrated in FIG. 8. The user can check at least one of tool description, features of the tool, video or picture related to a tool, and user reviews by selecting one of the tools from the list of tools in the section 714. Thus, the user can learn more about the tools. In an embodiment, the user can visualize ratings related to one or more tools in the exemplary user interface 702.

FIG. 8 is an illustration 800 of an exemplary user interface 802 that facilitates the user to manage information related to one or more manufacturers, according to an embodiment of the invention. The exemplary user interface 802 that facilitates the user to search, and manage information related to one of a supplier, a manufacturer, and an association. The exemplary user interface 802 provides a search bar 804 for searching different companies. Further, the user can perform a location-based search by selecting at least one of a city name from a drop-down menu 806, and selecting a distance from a drop-down menu 808. In response to the location-based search, the location of one or more manufacturers is displayed as one or more graphical icons on a graphical map 810. Further, the exemplary user interface 802 is configured to display a list of top manufacturers on the section 812. In an embodiment, the position of the top manufacturers is determined by a rating given by different users. The user can perform region-based search by selecting one or more checkboxes in the section 814. The user can search for one or more manufacturer by selecting one or more checkboxes related to type of materials in the section 816. In response to at least one of the location-based searches, the distance-based search, region-based search, material-based search, the exemplary user interface 802 displays information related to one or more manufacturers in section 820. The user can check information related to an individual manufacturer, for example, promotions, events, reviews, contact information, and the like by selecting a user interface element 822. The user can share the information about the manufacturer to other user by selecting a share button 824.

FIG. 9 is an illustration 900 of an exemplary user interface 902 that facilitates the user to manage information related to one or more suppliers, according to an embodiment of the invention. The exemplary user interface 902 that facilitates the user to search, and verify information related to one of a supplier, a manufacturer, and an association. The exemplary user interface 902 provides a search bar 904 for searching different supplier companies. Further, the user can perform a location-based search by selecting at least one of a city name from a drop-down menu 906, and selecting a distance from a drop-down menu 908. In response to the location-based search, the location of one or more suppliers is displayed as one or more graphical icons on a graphical map 910. Further, the exemplary user interface 902 is configured to display a list of top suppliers in the section 912. In an embodiment, the position of the top suppliers is determined by a rating given by different users. In another embodiment, the rating is given by the system for collecting, managing, processing and distributing information in multiple industry sectors, wherein the rating is based on one or more metrics. The user can perform region-based search by selecting one or more checkboxes in the section 914. The user can search for one or more suppliers by selecting one or more checkboxes related to type of materials on the section 916. In response to at least one of the location-based searches, the distance-based search, region-based search, material-based search, the exemplary user interface 902 is configured to display information related to one or more suppliers on section 920. The user can check information related to an individual supplier, for example, promotions, events, reviews, contact information, and the like by selecting a user interface element 922. The user can share the information about the supplier to other user by selecting a share button 924.

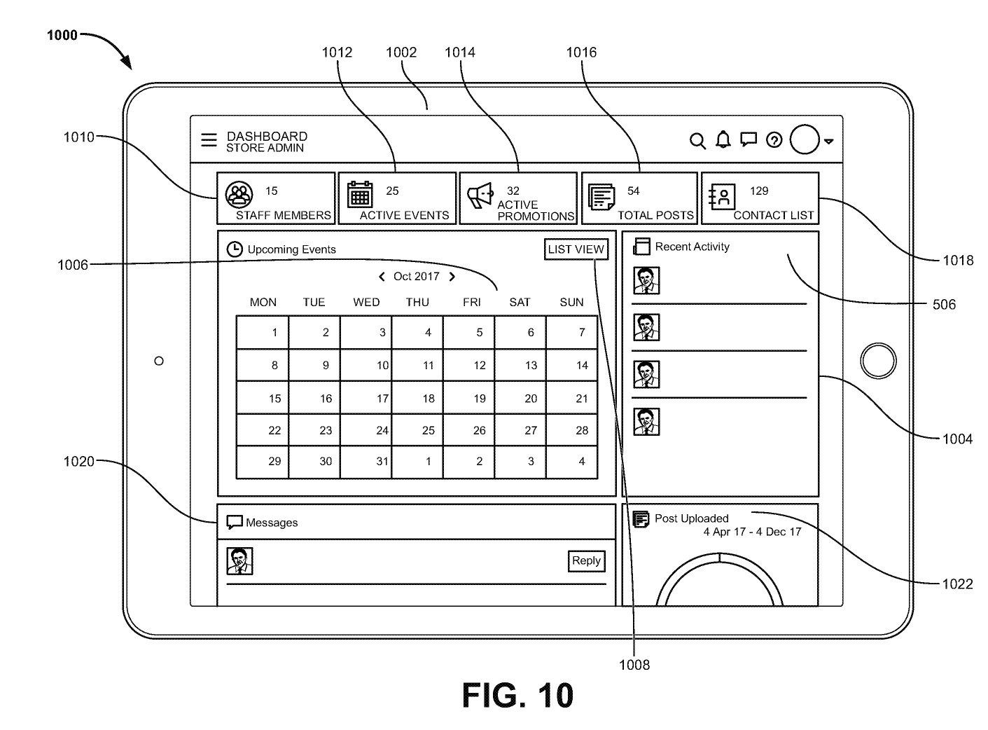

FIG. 10 is an illustration 1000 of an exemplary user interface 1002 of a dashboard that is accessed by a store administrator for managing activities related to one or more stores, according to an embodiment of the invention. One or more activities of a staff member is displayed in the section 1004. The activities can be sorted with most recent activity on the top and the historical activities at the bottom. Further, the user can check upcoming events related to the store in the section 1006. In an embodiment, the user can change a layout of the section 1006 to view the upcoming events, for example, list view by clicking a button 1008. In an embodiment, the event section is integrated with a calendar application. The event section may also be integrated with a third-party calendar application. Further, the user can check the number of staff members of the store by selecting the tab 1010. The user can check number of active events by selecting the tab 1012. The user can check number of active promotions of the store by selecting the tab 1014. The user can check number of total posts related to the store by selecting the tab 1016. The user can check number of contacts in a contact list of the store by selecting the tab 1018.The user can check or more messages on the section 1020. The user can check the number of posts, for example, news, promotions, and events, upload to the collaborative portal 120 on the section 1022.

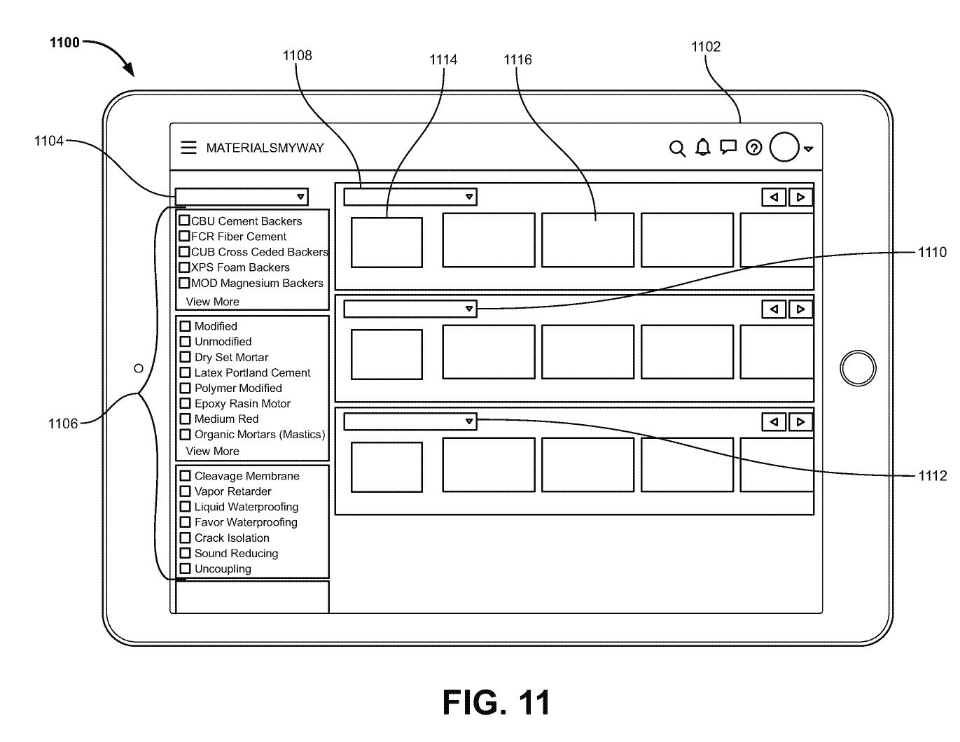

FIG. 11 is an illustration 1100 of an exemplary user interface 1102 that facilitate the user to manage one or more materials purchases, according to an embodiment of the invention. The exemplary user interface 1102 that facilitate the user to search, select and purchase one or more materials. The user selects a drop-down menu 1104 for choosing a menu, for example, materials. If the user selects the menu option as “materials”, one or more list of materials is displayed on the exemplary user interface 1102. The user can select one or more options on the section 1106 by selecting the checkboxes. Further, the user can select one or more types of materials from a drop-down menu 1108, 1110, and 1112. For example, the user may select the types of the material as “backer boards” from the drop-down menu 1108. In response to the user selection, name of the backer board manufacture or supplier is displayed on the section 1114 and list of materials are displayed on the section 1116. The user can check at least one of material description, features of the material, video or picture related to the material, and user reviews by selecting one of the material from the list of materials in the section 1116. In an embodiment, the user can visualize ratings related to one or more tools on the exemplary user interface 1102.

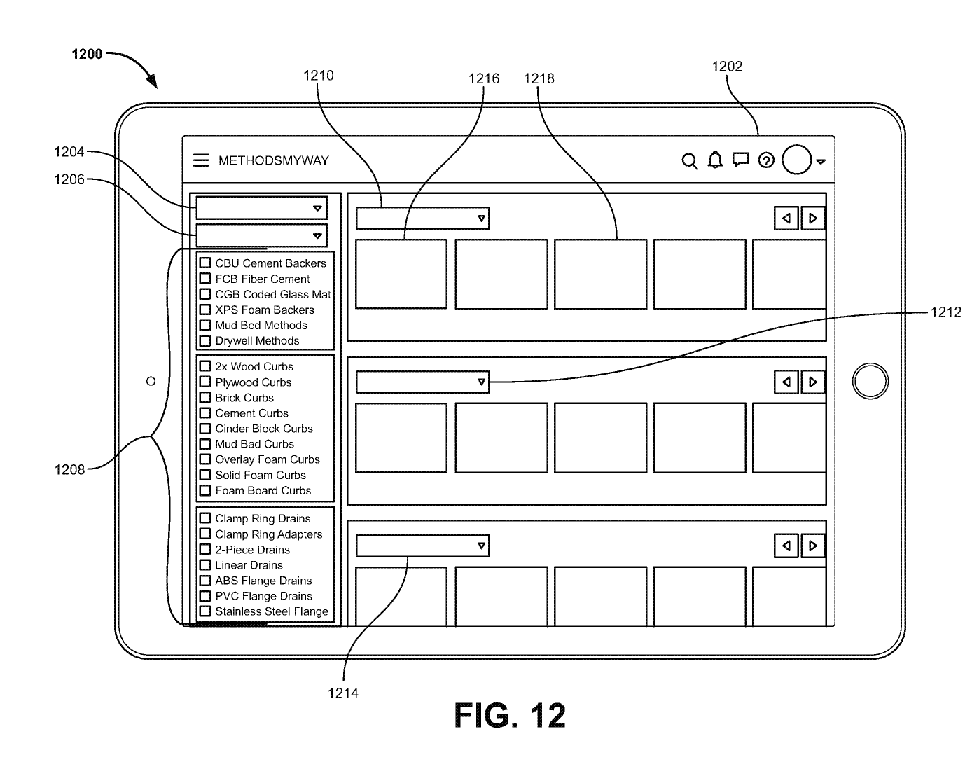

FIG. 12 is an illustration 1200 of an exemplary user interface 1202 that facilitate the user to search, and select three-dimensional illustrative image files related to installation methods from a variety of manufactures, according to an embodiment of the invention. The exemplary user interface 1202 is configured to receive a manufacturer-submitted specification for a construction item made up of constituent elements in a two-dimensional image file. For example, exemplary user interface 1202 is configured to receive a manufacturer-submitted specification such as materials required (i.e., ceramic tiles, coated glass mat, wood studs, and the like), dimensions of the materials, and quantity of the materials for a backer board of the shower wall. In an embodiment, the two-dimensional image may be a hand drawn image.

Further, exemplary user interface 1202 is configured to receive a contractor-submitted request for the construction item made up of constituent elements. For example, exemplary user interface 1202 is configured to receive the request for the backer board of the shower wall. Further, exemplary user interface 1202 is configured to generate a three-dimensional illustrative image file based on the two-dimensional image file, and the contractor-submitted request. Thus, by converting dull, flat, 2D images into rich, vibrant, information loaded 3D imagery, the exemplary user interface 1202 offers better industry product understanding. In use, the exemplary user interface 1202 allows users to view multiple images of a product category having the same view of different products, thereby reducing the time spent for learning by approximately 60,000 times. Additionally, the multiple images as disclosed herein also provide additional information to users, such as, for example, but not limited to, installation specifications, thereby reducing the reading time by hours as compared to conventional approach of reading from a technical installation literature. Therefore, embodiments of the present invention enable the users to learn about 100s and 1000s of new methods, products and developments across construction industry. Particularly, such images may be employed along with text and/or links, wherein image with text explains the specifications on how to install that method and/or product.

Further, the user selects a drop-down menu 1204 for choosing a menu item, for example, a particular company name. If the user selects the particular company name, then one or more list of the three-dimensional illustrative image file provided by the particular company are displayed on the exemplary user interface 1202. Further, the user can select a menu items from the drop-down menu 1206. The menu item can be an installation method from a manufacture. Further, the user can select one or more options in the section 1208 by selecting the checkboxes. Further, the user can select one or more types of installation method from a drop-down menu 1210, 1212, and 1214. For example, the user selects the types of the installation method as “Shower walls methods” from the drop-down menu 1210. In response to the user selection, name of the manufacture or supplier that provides the three-dimensional illustrative image file related to the shower wall methods is displayed in the section 1216 and a list of three-dimensional illustrative image file are displayed in the section 1218. The user can check three-dimensional illustrative image file of alternative methods, and user reviews by selecting one of the three-dimensional illustrative image files from the list of the three-dimensional illustrative image file in the section 1218.

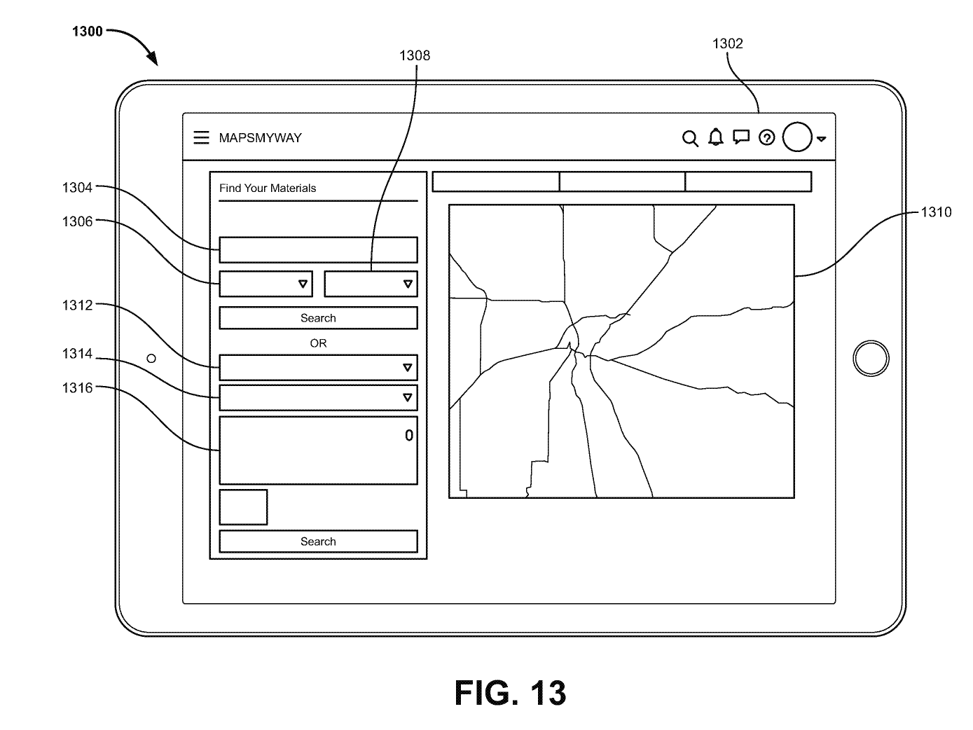

FIG. 13 is an illustration 1300 of an exemplary user interface 1302 that displays one or more graphical indicator on a graphical map 1310 in response to a user query for at least one of materials, tools, and suppliers, according to an embodiment of the invention. In an embodiment, the user can search a material by providing input to a search bar 1304, a first drop-down menu 1306, and a second drop down menu 1308. For example, the user can type name of the material as “Baker boards” on the search bar 1304. Further, the user may select the Zipcode, for example, 95765, on the first drop down menu 1306. Furthermore, the user may select radius as 5 miles or kms on the second drop down menu 1308. In response to the user input, the exemplary user interface 1302 is configured to display one or more graphical indicator on a graphical map 1310. In another embodiment, the user can search a material by providing input to a third drop down menu 1312 and a fourth drop down menu 1314. For example, the user selects a material category, for example, “Baker boards”, from the third drop down menu 1312. Further, the user may select a material, for example, “XPS foam bakers” from the fourth drop down menu 1314. In response to the user input, the exemplary user interface 1302 is configured to display one or more supplier name in a section 1316 of the exemplary user interface 1302. Upon selection of a supplier name, the exemplary user interface 1302 displays one or more graphical indicator on a graphical map 1310. Similarly, the exemplary user interface 1302 displays one or more graphical indicator on the graphical map 1310 in response to a user query related to materials, tools, representatives and suppliers. In an embodiment, upon clicking the graphical indicator corresponding to tool, the exemplary user interface 702 is displayed. The user interface 702 facilitates the user to search, select and purchase one or more tools. Further, the user can learn more about each tool by checking the information corresponding to each tool. The user can check at least one of tool description, features of the tool, video or picture related to a tool, and user reviews by selecting one of the tools from the list of tools. In another embodiment, upon clicking the graphical indicator corresponding to the material, the exemplary user interface 1102 is displayed. The exemplary user interface 1102 facilitates the user to search, select and purchase one or more materials.

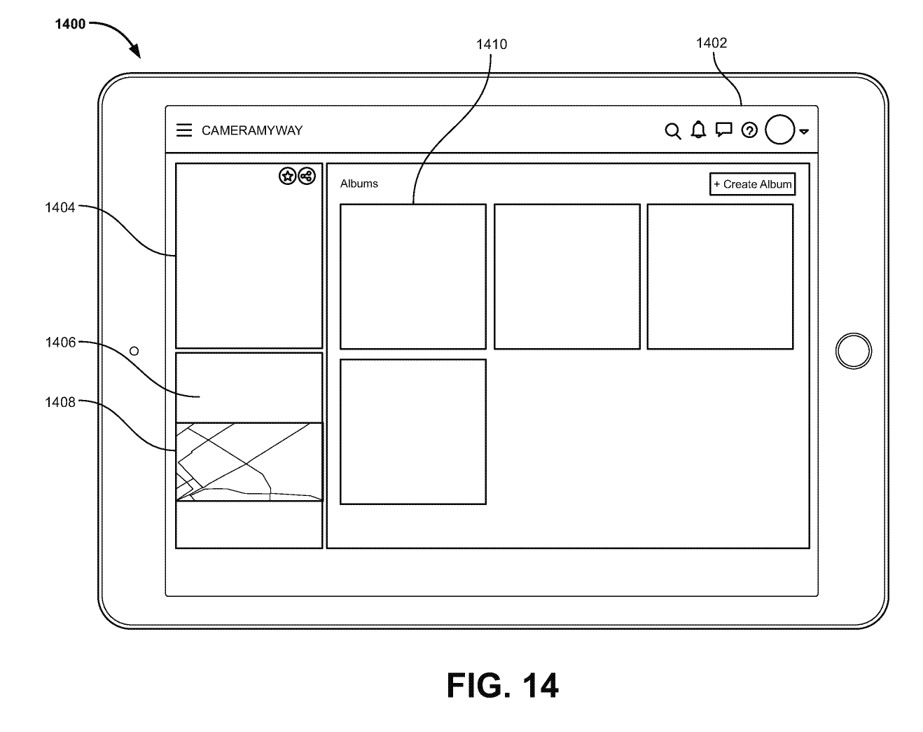

FIG. 14 is an illustration 1400 of an exemplary user interface 1402 that displays one or more group of images captured by one of the industry stakeholders, according to an embodiment of the invention. The exemplary user interface 1402 displays name of the industry stakeholder in section 1404 of the exemplary user interface 1402. Further, the user interface 1402 displays contact information of the industry stakeholder in section 1406 of the exemplary user interface 1402. Furthermore, the exemplary user interface 1402 displays one or more graphical indicator related to the location of the industry stakeholder on a graphical map 1408. Furthermore, the exemplary user interface 1402 facilitates the industry stakeholder to create a group of photos (i.e., photo album) by selecting an icon 1410, and subsequently adding one or more photos to the group. Further, the industry stakeholder can perform different activities on the one or more photos. For example, the industry stakeholder can edit the photo, modify one or more properties of a photo, delete a phone, tag a photo and so on.

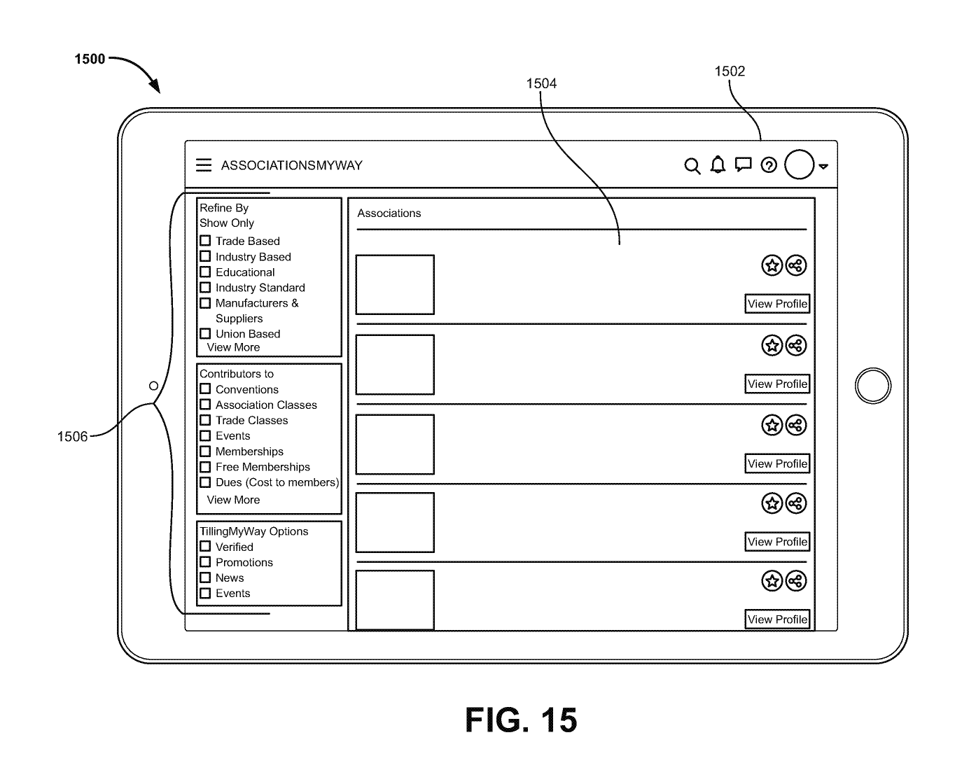

FIG. 15 is an illustration 1500 of an exemplary user interface 1502 that facilitate the user to manage information related to an association, according to an embodiment of the invention. The user interface 1502 that facilitate the user to browse, search and contact the association. The exemplary user interface 1502 displays a list of one or more association details in section 1504 of the exemplary user interface 1502. The user can refine the list by choosing one or more checkboxes in the section 1506. The user can further check more information (e.g, membership details, class scheduled, news related to the association, events of the association, reviews for the association by one or more users) about an association by selecting an individual association's name from the list displayed in the section 1504.

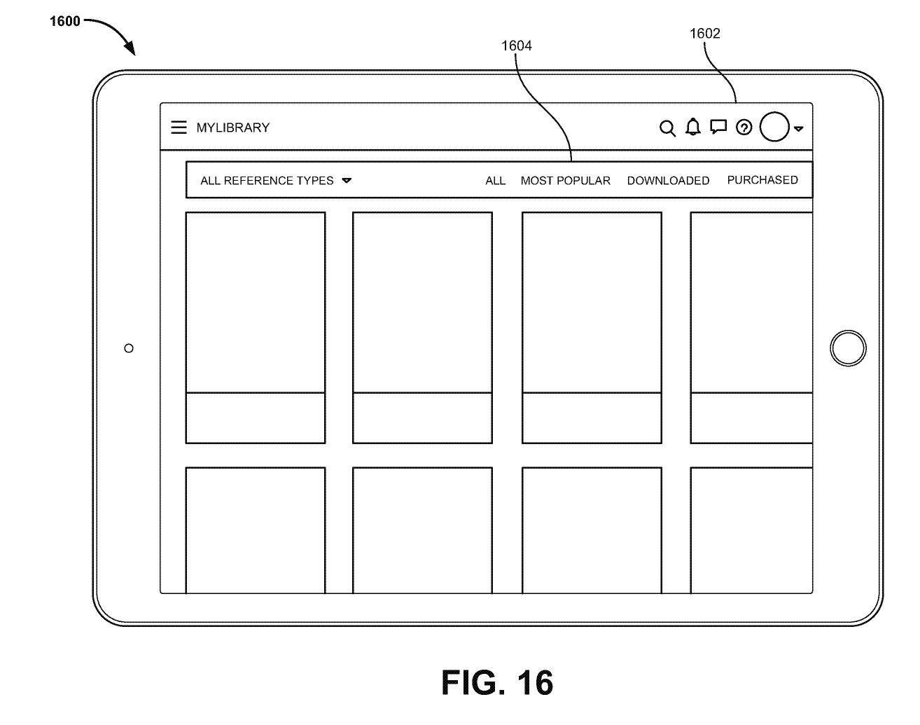

FIG. 16 is an illustration 1600 of an exemplary user interface 1602 that facilitates the user to browse, search, purchase and download one or more digital material, according to an embodiment of the invention. Examples of the digital material includes, but are not limited to, reference manuals, eBooks, flyers, and journals. The user can check most popular digital content by selecting a tab 1604.

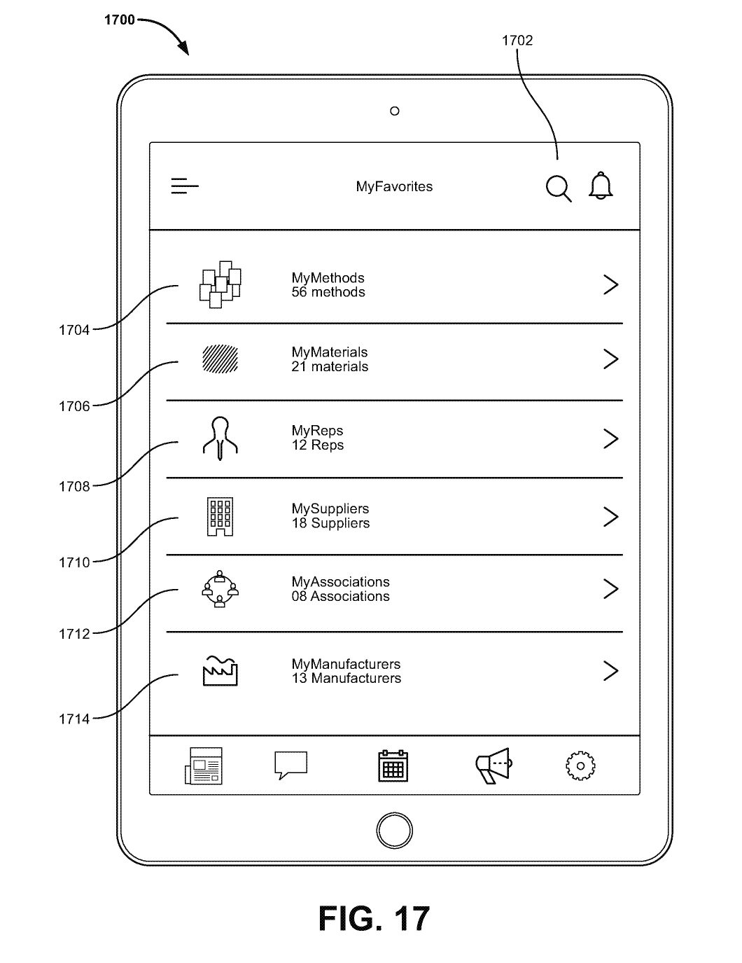

FIG. 17 is an illustration 1700 of an exemplary user interface 1702 that facilitates the user to bookmark and store information related to materials, tools, manufacturers, and suppliers as intended by the user, according to an embodiment of the invention. In use, embodiments of the present invention allow the users to retain a virtual bookmark of all their areas of interest in one or more industry sectors, such as, for example, construction, tiling, and the like. The user can check all the installation methods that are bookmarked on the exemplary user interface 1702 by selecting a user interface element 1704. Further, the user can check all the materials that are bookmarked on the exemplary user interface 1702 by selecting a user interface element 1706. Further, the user can check all the representatives that are bookmarked on the exemplary user interface 1702 by selecting a user interface element 1708. Further, the user can check all the suppliers that are bookmarked on the exemplary user interface 1702 by selecting a user interface element 1710. Further, the user can check all the association that are bookmarked on the exemplary user interface 1702 by selecting a user interface element 1712. Further, the user can check all the manufacturers that are bookmarked on the exemplary user interface 1702 by selecting a user interface element 1714.

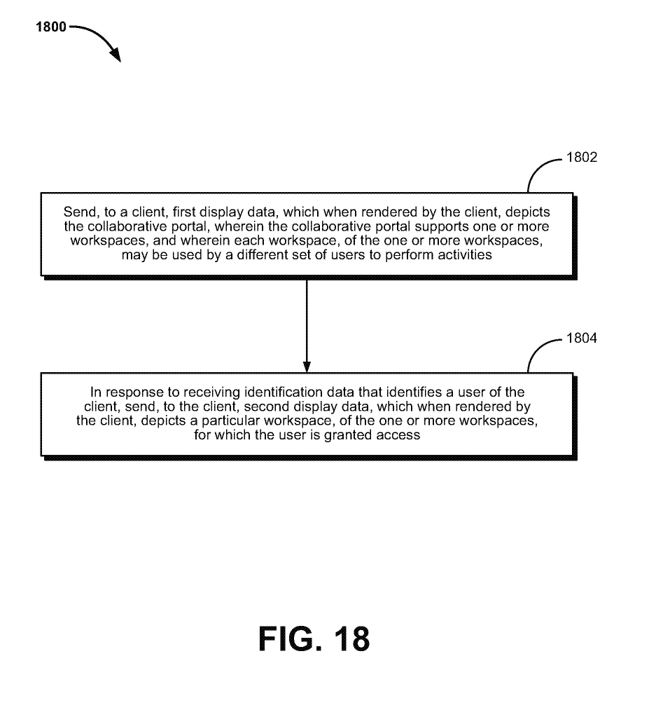

Referring to FIG. 18 is a flow chart 1800 illustrating a method for enabling a user of a client to perform activities on a collaborative portal, according to an embodiment as disclosed herein. At step 1802, the method includes sending, to the client, the first display data, which when rendered by the client, depicts the collaborative portal, wherein the collaborative portal supports one or more workspaces, and wherein each workspace, of the one or more workspaces, may be used by a different set of users to perform activities. The method allows the processor to send, to the client, the first display data, which when rendered by the client, depicts the collaborative portal, wherein the collaborative portal supports one or more workspaces, and wherein each workspace, of the one or more workspaces, may be used by a different set of users to perform activities.

At step 1804, the method includes a step of receiving identification data that identifies a user of the client, sending, to the client, the second display data, which when rendered by the client, depicts a particular workspace, of the one or more workspaces, for which the user is granted access. The method allows the processor to send, to the client, the second display data, which when rendered by the client, depicts a particular workspace, of the one or more workspaces, for which the user is granted access, in response to receiving identification data that identifies a user of the client.

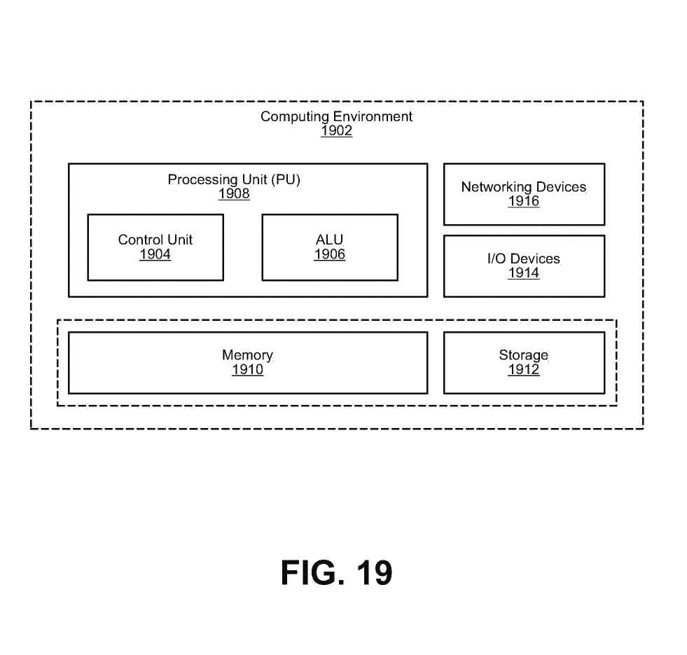

Referring to FIG. 19 illustrates a computing environment implementing the method for enabling a user of a client to perform activities on a collaborative portal, according to embodiments disclosed herein. As depicted in the figure, the computing environment 1902 comprises at least one processing unit 1908 that is equipped with a control unit 1904 and an Arithmetic Logic Unit (ALU) 1906, a memory 1910, a storage unit 1912, plurality of networking devices 1916 and a plurality Input output (I/O) devices 1914. The processing unit 1908 is responsible for processing the instructions of the technique. The processing unit 1908 receives commands from the control unit in order to perform its processing. Further, any logical and arithmetic operations involved in the execution of the instructions are computed with the help of the ALU 1906.

The overall computing environment 1902 can be composed of multiple homogeneous and/or heterogeneous cores, multiple CPUs of different kinds, special media and other accelerators. The processing unit 1908 is responsible for processing the instructions of the technique. Further, the plurality of processing units 1908 may be located on a single chip or over multiple chips.

The technique comprising of instructions and codes required for the implementation are stored in either the memory unit 1910 or the storage 1912 or both. At the time of execution, the instructions may be fetched from the corresponding memory 1910 or storage 1912, and executed by the processing unit 1908.

In case of any hardware implementations, various networking devices 1916 or external I/O devices 1914 may be connected to the computing environment to support the implementation through the networking unit and the I/O device unit.

The embodiments disclosed herein can be implemented through at least one software program running on at least one hardware device and performing network management functions to control the elements. The elements shown in the FIGS. 1 through 19 include user interfaces, blocks which can be at least one of a hardware device, software routines, or a combination of hardware device and software units.

The foregoing description of the specific embodiments will so fully reveal the general nature of the embodiments herein that others can, by applying current knowledge, readily modify or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

What is claimed is:

1. A machine-implemented method for enabling a user of a client to perform activities on a collaborative portal, comprising:
sending, to a client, first display data, which when rendered by the client, depicts the collaborative portal, wherein the collaborative portal supports one or more workspaces, and wherein each workspace of the one or more workspaces, may be used by a set of users to perform activities, and
in response to receiving identification data that identifies a user from the set of users of the client, sending, to the client, second display data, which when rendered by the client, depicts a particular workspace of the one or more workspaces, for which the user is granted access.

2. The machine-implemented method of claim 1, wherein the user can access different workspaces with a single sign-in.

3. The machine-implemented method of claim 1, wherein the particular workspace enables the user to:
track status of tasks by assigning responsibility of a particular task to a particular user having access to the particular workspace,
monitor progress of the particular task,
conduct interactive discussions with the particular user,
share files with other users having access to the particular workspace, and
provide rating to the particular user for the particular task.

4. The machine-implemented method of claim 1, the method further comprising: displaying the real-time status of the user on a graphical map.

5. The machine-implemented method of claim 1, the method further comprising: managing and distributing information across at least one industry, comprising:
detecting, by a central computing device, an input performed by a user, wherein the input is performed to access at least one of an application resources, a processor, a memory unit, and a Graphical User Interface (GUI) available within the central computing device;
determining, by the central computing device, nature of information required by the user in response to detecting the input, wherein the nature of information is dynamically determined by identifying at least one aspect of user access to determine whether the user is searching for a support type of information;
extracting, by the central computing device, the information based on at least one parameter selected by the user in response to determining that the user is searching for the support type of information; and
distributing, by the central computing device, the information by rendering the information as a result list to the user.

6. The machine-implemented method of claim 5, wherein the result list comprises at least one of product information, service information, query status information, and an electronic link provided to a website of one or more external and internal information sources depending on requirements of the user.

7. The machine-implemented method of claim 5, wherein the method further comprises bookmarking and storing information related to the materials, tools, manufacturers, and suppliers as intended by the user.

8. The machine-implemented method of claim 1, wherein the method further comprises
receiving a manufacturer-submitted specification for a construction item made up of constituent elements in a two-dimensional image file;
receiving a contractor-submitted request for the construction item made up of constituent elements; and
generating a three-dimensional illustrative image file based on the two-dimensional image file, and the contractor-submitted request.

9. A system for enabling a user of a client to perform activities on a collaborative portal, the system comprising:
a memory;
a processor, coupled to the memory, configured to:
send, to a client, first display data, which when rendered by the client, depicts the collaborative portal, wherein the collaborative portal supports one or more workspaces, and wherein each workspace, of the one or more workspaces, may be used by a different set of users to perform activities, and
in response to receiving identification data that identifies a user of the client, send, to the client, second display data, which when rendered by the client, depicts a particular workspace, of the one or more workspaces, for which the user is granted access.

10. The system of claim 9, wherein the user can access different workspaces with a single sign-in.

11. The system of claim 9, wherein the particular workspace enables the user to:
track status of tasks by assigning responsibility of a particular task to a particular user having access to the particular workspace,
monitor progress of the particular task,
conduct interactive discussions with the particular user,
share files with other users having access to the particular workspace, and
provide rating to the particular user for the particular task.

12. The system of claim 9, wherein the processor further configured to display the real-time status of the user on a graphical map.

13. The system of claim 9, wherein the processor further configured to:
detect, by a central computing device, an input performed by a user, wherein the input is performed to access at least one of an application resources, a processor, a memory unit, and a Graphical User Interface (GUI) available within the central computing device;
determine, by the central computing device, nature of information required by the user in response to detecting the input, wherein the nature of information is dynamically determined by identifying at least one aspect of user access to determine whether the user is searching for a support type of information;
extract, by the central computing device, the information based on at least one parameter selected by the user in response to determining that the user is searching for the support type of information; and
distribute, by the central computing device, the information by rendering the information as a result list to the user.

14. The system of claim 9, wherein the processor further configured to bookmark and store all the materials, tools, manufacturers, and suppliers as intended by the user.

15. The system of claim 9, wherein the result list comprises at least one of product information, service information, query status information, and an electronic link provided to a website of one or more external and internal information sources depending on requirements of the user.

16. The system of claim 9, wherein the system further configured to
receive a manufacturer-submitted specification for a construction item made up of constituent elements in a two-dimensional image file;
receive a contractor-submitted request for the construction item made up of constituent elements; and
generate a three-dimensional illustrative image file based on the two-dimensional image file, and the contractor-submitted request.
